(19) United States
(12) Patent Application Publication
(10) Pub. No.: US 2014/0241690 A1
(43) Pub. Date: Aug. 28, 2014

(54) OPTICAL FIBER ADAPTER

(71) Applicant: EZONTEK TECHNOLOGIES CO., LTD., Taipei City (TW)

(72) Inventors: SUNG-AN LIN, TAIPEI CITY (TW); SUNG-CHI LIN, TAIPEI CITY (TW)

(21) Appl. No.: 13/940,426

(22) Filed: Jul. 12, 2013

(30) Foreign Application Priority Data
Feb. 23, 2013 (TW) 102106480

(51) Int. Cl. G02B 6/36

(52) U.S. Cl. CPC G02B 6/36
USPC 385/135

(57) ABSTRACT

An optical fiber adapter according to the present invention includes four walls defined as first wall, second wall, third wall and fourth wall, respectively, wherein the first wall faces the third wall and connects with the second and fourth walls. The four walls define an accommodation room. Two tabs extend outward from two opposing walls of the four walls, respectively. An elastic first stopping portion extends from the first wall and is configured to press against a surface of a panel.

### CROSS REFERENCE TO RELATED APPLICATION

This application claims the priority benefit of Taiwan Patent Application Serial Number 102106480 filed Feb. 23, 2013, the full disclosure of which is incorporated herein by reference.

### BACKGROUND

1. Technical Field

The disclosure relates to an optical fiber adapter.

2. Description of the Related Art

Referring to FIGS. 1 and 2, an optical fiber adapter 100 with a conventional clip includes a molded plastic main body 110 and a metal clip 150. The main body 110 is of rectangular shape and has an axial accommodation room 115 defined by a top side-wall 111, a bottom side-wall 112, a right side-wall 113 and a left side-wall 114. A recess 116 is formed on each of the top side-wall 111, the right side-wall 113 and the left side-wall 114. These recesses 116 are positioned in communication with each other. In addition, a pair of tabs 119 extends outward from the right side-wall 113 and the left side-wall 114, respectively.

The clip 150 made of metal includes two vertical portions 154 extending downward from two opposing ends of a horizontal portion 152, wherein the horizontal portion 152 is positioned in the recess 116 on the top side-wall 111 and the two vertical portions 154 are positioned in the recesses 116 on the right side-wall 113 and the left side-wall 114, respectively. The vertical portions 154 are generally rectangular and each of them has a rectangular opening 155. An elastic stopping portion 158 extends from a side 157 of the opening 155. The stopping portions 158 are generally rectangular and extend outward and toward the tabs 119 on the main body 110, respectively.

Referring to FIGS. 3a and 3b, when desiring to mount the above optical fiber adapter 100 on a panel 210, the stopping portions 158 of the clip 150 attached to the main body 110 are passed through an opening 212 on the panel 210 and the tabs 119 are brought into contact with the panel 210. After the stopping portions 158 have passed through the opening 212, a pull on the main body 110 will cause the rear ends of the stopping portions 158 to be in contact with the rear side of the panel 210. This may prevent the main body 110 from being pulled out of the panel 210.

However, the clip 150 is made of metal and therefore fails to be integrated with the plastic main body 110.

Accordingly, there exists a need to provide a solution to solve the aforesaid problems.

### SUMMARY

The present disclosure provides an optical fiber adapter.

In one embodiment, the optical fiber adapter according to the present disclosure includes four walls defined as first wall, second wall, third wall and fourth wall, respectively, wherein the first wall faces the third wall and connects with the second and fourth walls. The four walls define an accommodation room. Two tabs extend outward from two opposing walls of the four walls, respectively. An elastic first stopping portion extends from the first wall and is configured to press against a surface of a panel.

The foregoing, as well as additional objects, features and advantages of the disclosure will be more readily apparent from the following detailed description, which proceeds with reference to the accompanying drawings.

### BRIEF DESCRIPTION OF THE DRAWINGS

FIG. 1 is an elevated perspective view illustrating an optical fiber adapter with a conventional clip, wherein the clip is separated from the main body of the optical fiber adapter.

FIG. 2 is an elevated perspective view illustrating an optical fiber adapter with a conventional clip.

FIGS. 3a and 3b illustrate how to mount the optical fiber adapter of FIG. 2 on a panel.

FIG. 4 is an elevated perspective view of the optical fiber adapter according to the present disclosure.

FIG. 5 is another elevated perspective view of the optical fiber adapter according to the present disclosure.

FIGS. 6, 7 and 8 illustrate that the optical fiber adapter of the present disclosure is mounted on a panel.

FIG. 9 is an elevated perspective view illustrating that a plurality of the optical fiber adapters of the present disclosure are stacked up.

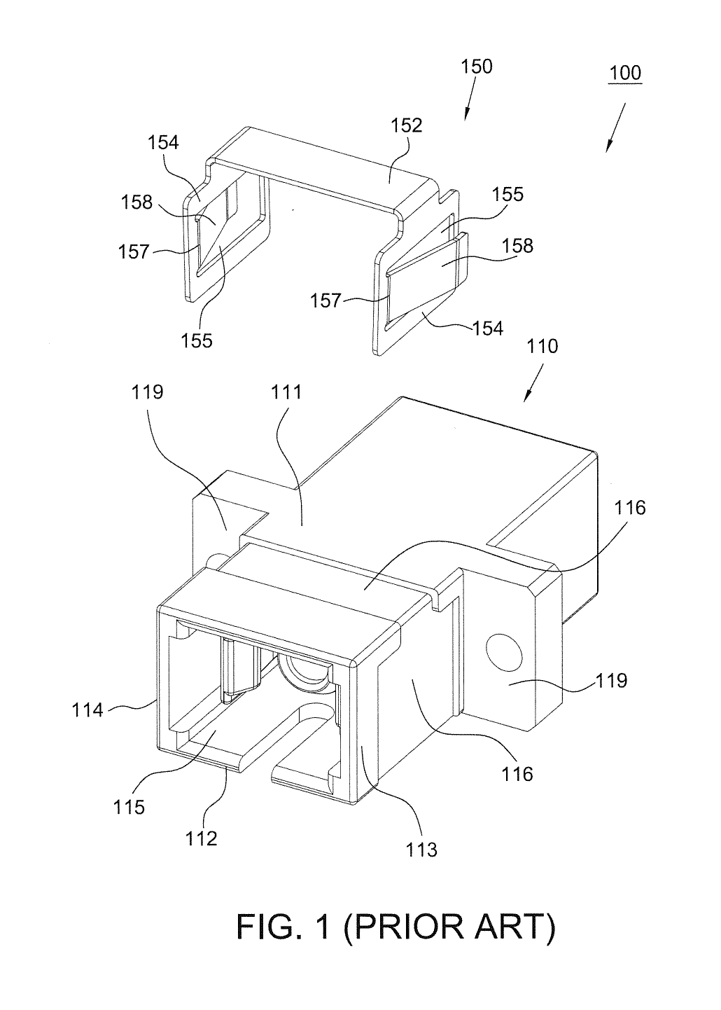

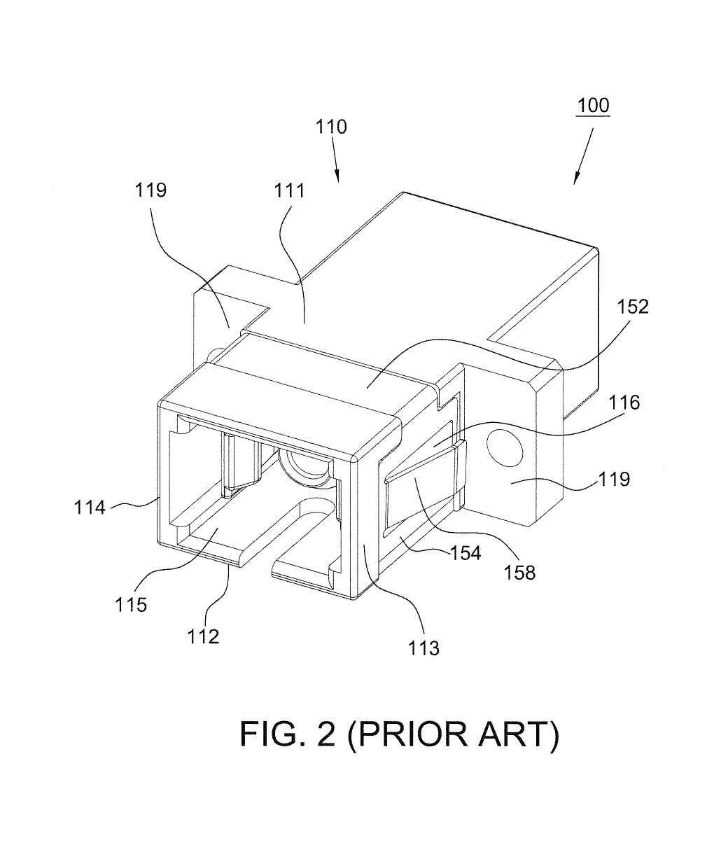

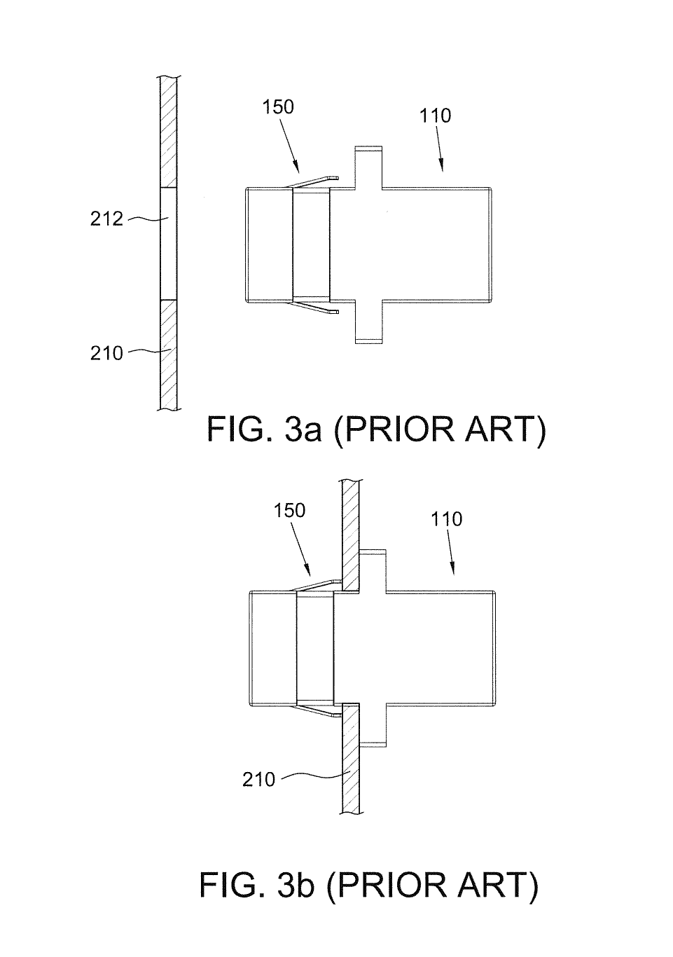

### DETAILED DESCRIPTION OF THE PREFERRED EMBODIMENT

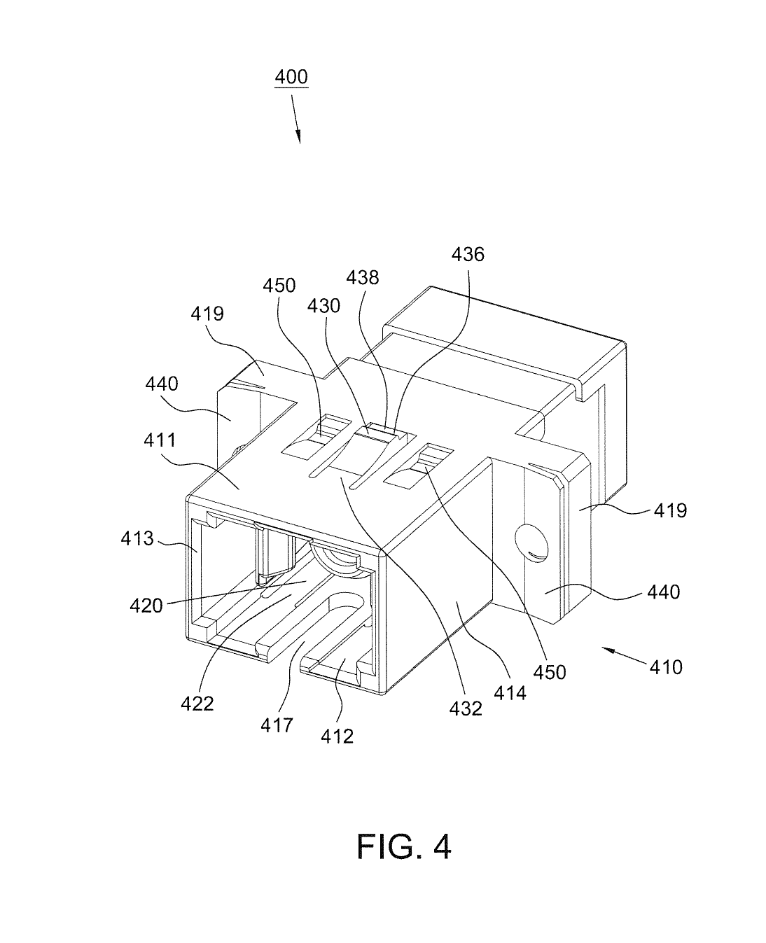

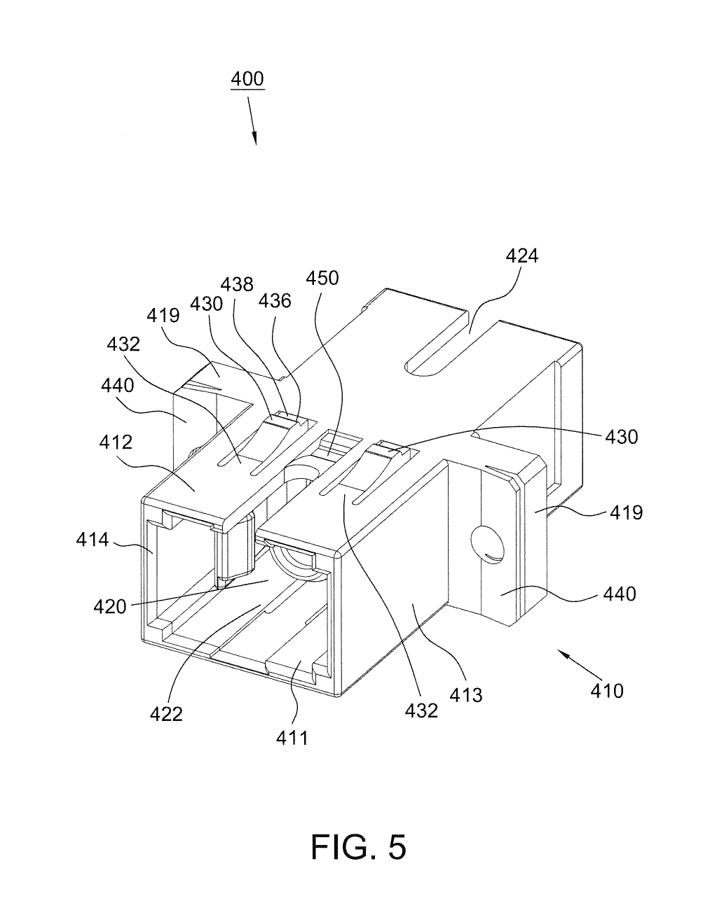

Referring to FIGS. 4 and 5, the optical fiber adapter 400 according to the present disclosure includes a unitary molded plastic main body 410. In the preferred embodiment, the main body 410 is rectangular and has an accommodation room 420 in an axial direction defined by top wall 411, bottom wall 412, right wall 413 and left wall 414. The accommodation room 420 of the main body 410 has opposing first opening 422 and second opening 424 in the axial direction. A pair of tabs 419 extends outward from the right wall 413 and the left wall 414, respectively.

In addition, an elastic stopping portion 430 extends in the axial direction from the top wall 411 and toward the second opening 424. Similarly, at least one elastic stopping portion 430, for example, two stopping portions 430 extend in the axial direction from the bottom wall 412 and toward the second opening 424, wherein the stopping portions 430 on the bottom wall 412 are positioned on two opposing sides of a slot 417 that is configured to be mated with a key of an optical fiber connector. The stopping portions 430 have roots 432 fixed on the top or the bottom wall 411, 412 and rear ends 436 away from the roots 432. The stopping portions 430 gradually become thicker toward the rear ends 436 thereof. The rear ends 436 are flat and a platform 438 extends from each of the rear ends 436. The platform 438 is higher than the surface of the top or bottom wall 411, 412 and the angle between the platform 438 and the flat rear end 436 is greater than 90 degrees. Two elastic sheets 440 are formed on the right and left walls 413, 414, respectively, or on the two tabs 419, respectively. The elastic sheets 440 are generally parallel to the tabs 419, respectively.

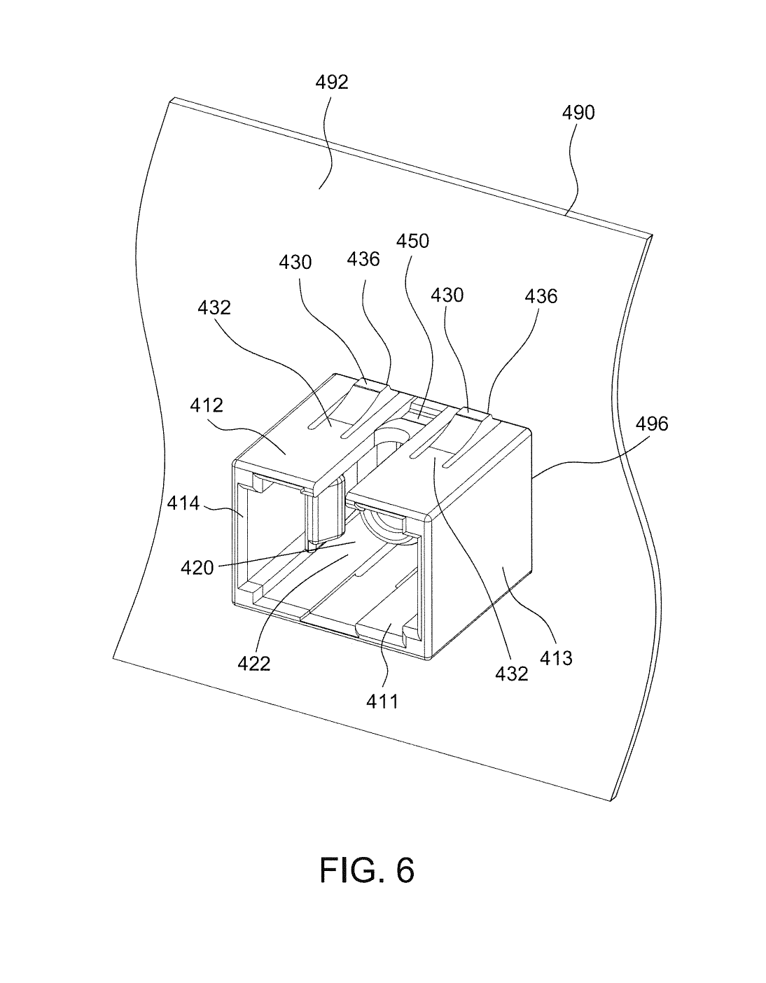

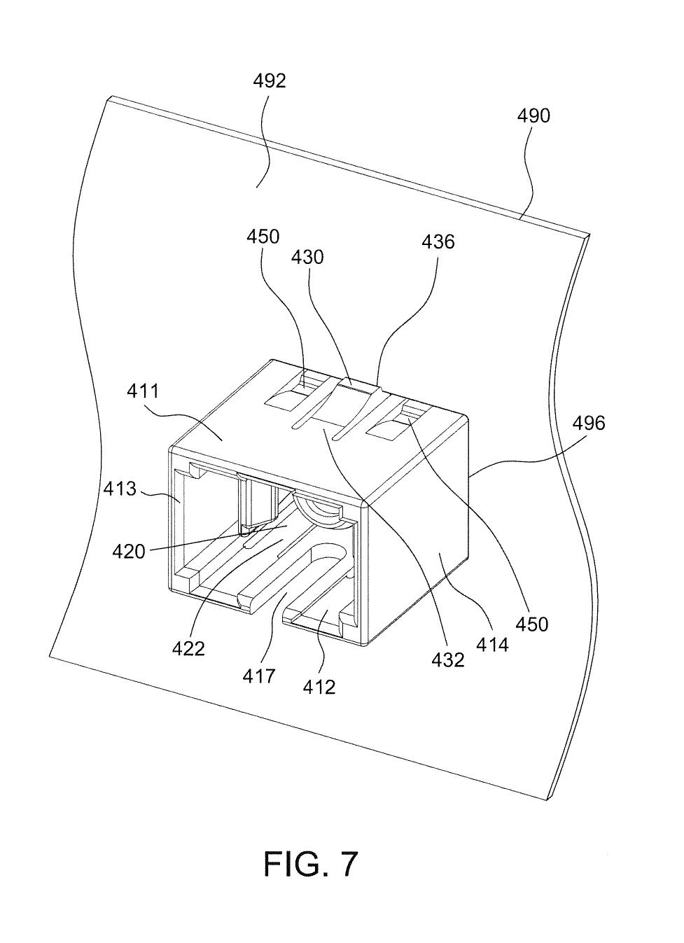

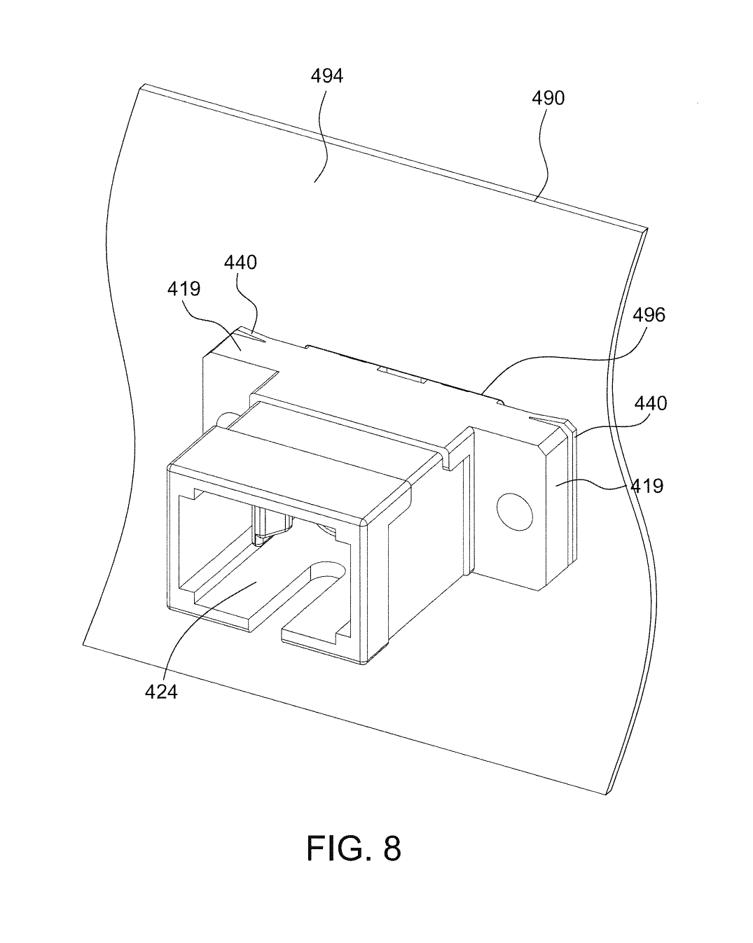

Referring to FIGS. 6, 7 and 8, when desiring to mount the optical fiber adapter 400 of the present disclosure on a panel 490, the main body 410 is inserted into the opening 496 of the panel 490 and the elastic sheets 440 are brought into contact with a surface 494 of the panel 490. Since the stopping portions 430 are elastic, the platforms 438 of the stopping portions 430 are pressed down by inner walls of the opening 496 and the rear ends 436 are forced to press against another surface 492 of the panel 490.

According to the present disclosure, the elastic sheets 440 are pressed against the surface 494 of the panel 490 and the rear ends 436 of stopping portions 430 are pressed against the surface 492 of the panel 490 when the optical fiber adapter 400 is mounted on the panel 490. Accordingly, the optical fiber adapter 400 will not rattle on the panel 490. In addition, the platforms 438 of the stopping portions 430 are pressed against the inner walls of the opening 496 and therefore may prevent the main body 410 from tilt on the panel 490.

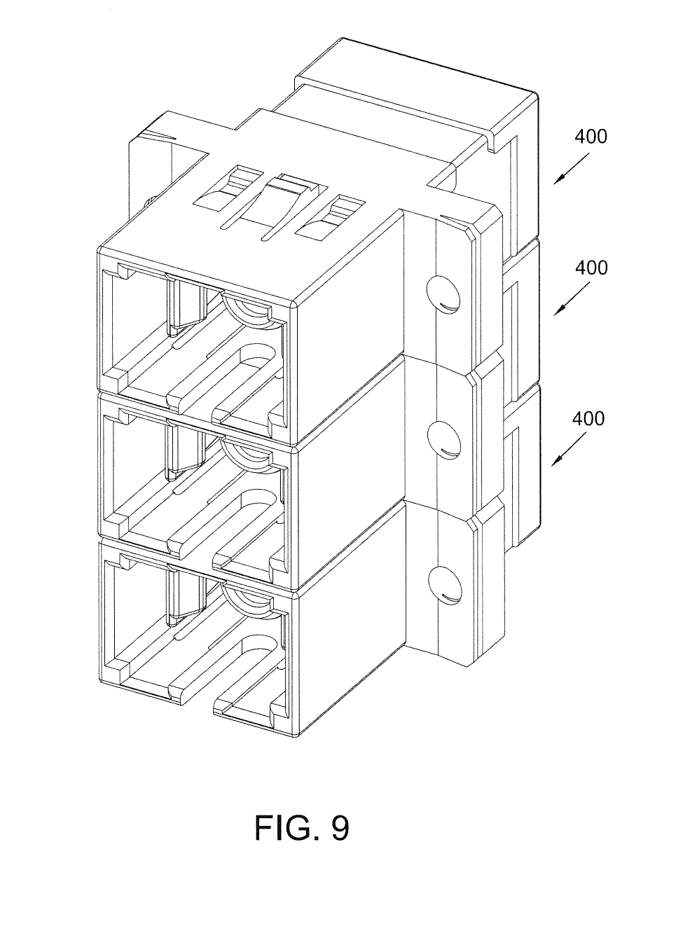

Referring to FIG. 9, it illustrates that a plurality of the optical fiber adapters 400 are stacked up. Referring to FIGS. 4 and 5 again, in order to receive the stopping portions 430 of adjacent optical fiber adapters 400 when the optical fiber adapters 400 are stacked up, indentations 450 are formed on the top and bottom walls 411, 412. Two indentations 450 are formed on the top wall 411 and positioned corresponding to the stopping portions 430 formed on the bottom wall 412 to receive the stopping portions 430 formed on the bottom wall 412 of other optical fiber adapter 400. One indentation 450 is formed on the bottom wall 412 and positioned corresponding to the stopping portion 430 formed on the top wall 411 to receive the stopping portion 430 formed on the top wall 411 of other optical fiber adapter 400.

It will be appreciated that the stopping portions 430 may be formed on the right or left wall 413, 414 in addition to on the top and bottom walls 411, 412.

According to the present disclosure, the stopping portions 430 and elastic sheets 440 are plastic and therefore may be integrally formed with the main body 410. Accordingly, the production costs of the optical fiber adapter 400 of the present disclosure are lower than the production costs of conventional optical fibers with metal clips.

Although the preferred embodiments of the disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. An optical fiber adapter, the optical fiber adapter being configured to be mounted on an opening on a panel, wherein the panel has opposing first and second surfaces, the optical fiber adapter comprising:
four walls defined as first, second, third and fourth walls, respectively, wherein the first wall faces the third wall and connects with the second and fourth walls, the four walls define an accommodation room;
two tabs extending from two opposing walls of the four walls, respectively; and
an elastic first stopping portion extending from the first wall, wherein the first stopping portion is configured to press against the first surface of the panel.

2. The optical fiber adapter as claimed in claim 1, wherein the first stopping portion has a rear end, a platform extends from the rear end of the firs stopping portion and is configured to press against an inner wall of the panel.

3. The optical fiber adapter as claimed in claim 2, wherein the rear end of the first stopping portion is configured to press against the first surface of the panel.

4. The optical fiber adapter as claimed in claim 2, wherein an angle between the platform and the rear end of the first stopping portion is greater than 90 degrees.

5. The optical fiber adapter as claimed in claim 1, further comprising:
at least one elastic second stopping portion extending from the third wall, wherein the second stopping portion is configured to press against the first surface of the panel.

6. The optical fiber adapter as claimed in claim 5, wherein the optical fiber adapter has two second stopping portions positioned on two opposing sides of a slot formed on the third wall.

7. The optical fiber adapter as claimed in claim 1, further comprising:
two elastic sheets positioned on the tabs, respectively, wherein the elastic sheets are configured to press against the second surface of the panel.

8. The optical fiber adapter as claimed in claim 1, wherein an indentation is formed on the third wall and is positioned corresponding to the first stopping portion on the first wall.

9. The optical fiber adapter as claimed in claim 7, wherein the tabs are positioned on the second and fourth walls, respectively.

10. The optical fiber adapter as claimed in claim 1, wherein the first stopping portion is integrally formed with the first wall.

11. The optical fiber adapter as claimed in claim 6, wherein the second stopping portions are integrally formed with the third wall.

12. The optical fiber adapter as claimed in claim 7, wherein the elastic sheets are integrally formed with the tabs, respectively.
